(19) United States
(12) Patent Application Publication
(10) Pub. No.: US 2025/0274794 A1
(43) Pub. Date: Aug. 28, 2025

(54) MANAGED ENTITY FEASIBILITY CHECK WITH AUTOMATIC ENABLER FEASIBILITY CHECK

(71) Applicant: Lenovo (Singapore) Pte. Limited, Singapore (SG)

(72) Inventor: Ishan Vaishnavi, München (DE)

(73) Assignee: Lenovo (Singapore) Pte. Limited, Singapore (SG)

(21) Appl. No.: 18/858,030

(22) PCT Filed: Apr. 20, 2023
(86) PCT No.: PCT/IB2023/054058

§ 371 Date: Oct. 18, 2024

Related U.S. Application Data
(60) Provisional application No. 63/333,481, filed on Apr. 21, 2022.

(51) Int. Cl. H04W 24/10

(52) U.S. Cl. CPC H04W 24/10

(57) ABSTRACT

Various aspects of the present disclosure relate to feasibility checks for accessing managed entities. Feasibility checks for automation enablers are performed as part of the feasibility check for a managed entity. This enables a complete solution to coherently support for automation where a managed entity specification can be used to provision the service or slice including the automation enablers that support the slice. Coherent in this context means that the system is sure that provisioning in all managed domains will go through.

### RELATED APPLICATION

This application claims priority to U.S. Patent Application Ser. No. 63/333,481 filed Apr. 21, 2022 entitled “Managed Entity Feasibility Check with Automatic Enabler Feasibility Check,” the disclosure of which is incorporated by reference herein in its entirety.

### TECHNICAL FIELD

The present disclosure relates to wireless communications, and more specifically to performing feasibility checks on automation enablers.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

Feasibility checks can be performed to determine whether deployment of a managed entity will go through. For example, a feasibility check may be performed when deploying various managed entities in a wireless communications system, such as network slice instances or network slice subnet instances.

### SUMMARY

The present disclosure relates to methods, apparatuses, and systems that support managed entity feasibility check with automatic enabler feasibility check. Feasibility checks for automation enablers are performed as part of the feasibility check for a managed entity. This enables a complete solution to coherently support for automation where the managed entity specification could be used to provision the service or slice including the automation enablers that support the slice. Coherent in this context means that the system is sure that provisioning in all managed domains will go through. By utilizing the described techniques, feasibility checks take into account automation enablers, providing a more accurate feasibility check than performing a feasibility check on solely the managed entity.

Some implementations of the method and apparatuses described herein may include wireless communication at a device (e.g., a UE), and the device receives a service description for a managed entity in a management domain; derive, from the service description, one or more automation enablers configurable in the management domain; perform a feasibility check for the entity as well as the one or more automation enablers; and output, based at least in part on the feasibility check, an indication of feasibility success or feasibility failure.

In some implementations of the method and apparatuses described herein, the device receives a request for reservation of resources associated with the managed entity for a given time period; reserves, in response to the feasibility check indicating success, the resources for the given time period; and releases, after the given time period, the resources. Additionally or alternatively, the device performs the feasibility check and output the indication of feasibility success or feasibility failure each time access to the managed entity is requested. Additionally or alternatively, the service description is for a communication service, and the device: transmits, to an additional management domain, a part of the service description corresponding to a part of the communication service that can be hosted by the additional management domain; and receives, from the additional management domain, an indication of feasibility success or feasibility failure resulting from the additional management domain performing a feasibility check for one or more automation enablers derived by the additional management domain from the part of the service description. Additionally or alternatively, the service description is received from an additional management domain and the indication of feasibility success or feasibility failure is output by transmitting the indication of feasibility success or feasibility failure to the additional management domain. Additionally or alternatively, the device: performs, as part of the feasibility check, a feasibility check on at least one of resources required by one of the one or more automation enablers; performs, as part of the feasibility check, a feasibility check on appropriate authorizations for the one of the one or more automation enablers; and performs, as part of the feasibility check, a feasibility check on data used by the one of the one or more automation enablers. Additionally or alternatively, the device: performs, as part of the feasibility check, a feasibility check on an analytics model that is one of the one or more automation enablers. Additionally or alternatively, the device: performs, as part of the feasibility check, a feasibility check on a closed loop that is one of the one or more automation enablers. Additionally or alternatively, the one or more automation enablers include at least one of an analytics model, a closed loop, or an assurance goal. Additionally or alternatively, the managed entity comprises a network slice instance, a network slice subnet instance, a network function, or an end to end service.

### BRIEF DESCRIPTION OF THE DRAWINGS

Various aspects of the present disclosure for managed entity feasibility check with automatic enabler feasibility check are described with reference to the following Figures. The same numbers may be used throughout to reference like features and components shown in the Figures.

FIG. 1 illustrates an example of a wireless communications system that supports managed entity feasibility check with automatic enabler feasibility check in accordance with aspects of the present disclosure.

FIG. 2 illustrates an example of an open loop.

FIG. 3 illustrates an example of a closed loop.

FIG. 4 illustrates an example of an information model that supports managed entity feasibility check with automatic enabler feasibility check in accordance with aspects of the present disclosure.

FIG. 5 illustrates an example of a logical representation of management domains that supports managed entity feasibility check with automatic enabler feasibility check in accordance with aspects of the present disclosure.

FIG. 6 illustrates an example of a deployment scenario of management domains that supports managed entity feasibility check with automatic enabler feasibility check in accordance with aspects of the present disclosure.

FIG. 7 illustrates an example of generating a service description that supports managed entity feasibility check with automatic enabler feasibility check in accordance with aspects of the present disclosure.

FIGS. 8A, 8B, 9, and 10 illustrate examples of feasibility checks that support managed entity feasibility check with automatic enabler feasibility check in accordance with aspects of the present disclosure.

FIG. 11 illustrates an example block diagram of components of a device (e.g., a UE) that supports managed entity feasibility check with automatic enabler feasibility check in accordance with aspects of the present disclosure.

FIG. 12 illustrates an example block diagram of components of a device (e.g., a network device or base station) that supports managed entity feasibility check with automatic enabler feasibility check in accordance with aspects of the present disclosure.

FIGS. 13-16 illustrate flowcharts of methods that support managed entity feasibility check with automatic enabler feasibility check in accordance with aspects of the present disclosure.

### DETAILED DESCRIPTION

Implementations of managed entity feasibility check with automatic enabler feasibility check are described. A managed entity refers to any of various resources that may be controlled or managed by a management domain, such as network slice instances, network slice subnet instances, network functions or end to end (E2E) services. Feasibility check is a feature prior to deploying managed entities. Feasibility checks and reservation enables the upper-level management domain to ensure prior to deployment that the deployment will go through all the composing management domains. Feasibility checks for automation enablers are performed as part of the feasibility check for a managed entity. This enables a complete solution to coherently support for automation where the managed entity specification could be used to provision the service or slice including the automation enablers that support the slice. Coherent in this context means that the system is sure that provisioning in all managed domains will go through.

Supporting and managing complex networks with multiple slices implies automation is relevant to the next generation of wireless communication networks. One enabler for such automation is closed loops. A closed loop is associated with a set of goals, which can be configured to the closed loop by the appropriate authorized entity. These goals can be determined based on the service description and the operator preferences configured in the network. These closed loops are automation enablers used by an automation system to manage the managed entities. By performing the feasibility check on these automation enablers, before deploying or granting access to a managed entity the ability of the automation system to support and manage the access is verified.

By utilizing the described techniques, feasibility checks take into account automation enablers, providing a more accurate feasibility check than performing a feasibility check on solely the managed entity. Current feasibility check techniques only check for resources used by the managed entity itself. For example, the current feasibility check process has focused on the resources that support the core functioning of the slice subnet, slice or communication service. Current feasibility check techniques do not check the resources and the feasibility of the automation system. In some cases, a vertical or operator may require that the automation system be deployed together with the managed entity. Accordingly, by utilizing the described techniques the feasibility of deployment of the managed entity, along with the automation system, is verified.

Furthermore, the techniques described herein provide a truly automated system. This alleviates the need of having a human operator for the system, and can reduce capital expenditure for the operator.

Aspects of the present disclosure are described in the context of a wireless communications system. Aspects of the present disclosure are further illustrated and described with reference to device diagrams and flowcharts that relate to managed entity feasibility check with automatic enabler feasibility check.

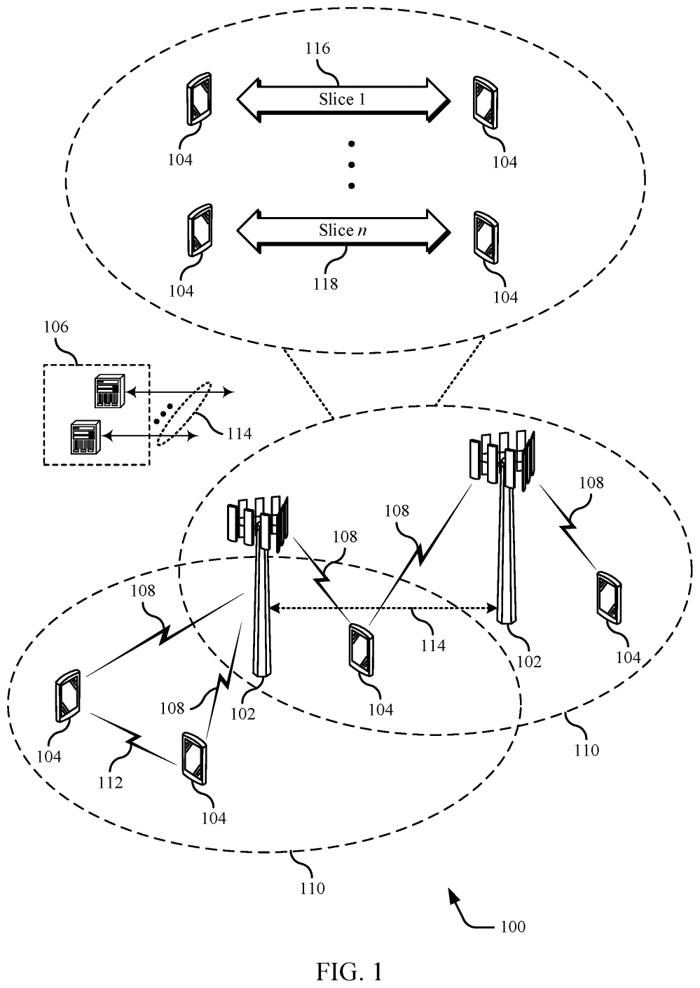

FIG. 1 illustrates an example of a wireless communications system 100 that supports managed entity feasibility check with automatic enabler feasibility check in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

In one or more implementations, the wireless communications system 100 supports network slicing. Network slicing refers to a network architecture in which multiple logical networks are multiplexed on a physical network infrastructure. The different network slices (also referred to as simply slices) can be suited to different use cases, such as supporting different quality of service (QOS) levels or requirements. For example, one network slice may be suited to high bandwidth, another network slice may be suited to low latency, another network slice may be suited to having a vary large number of connected devices, and so forth. Multiple (n) network slices 116, 118 are illustrated in FIG. 1. An automation system is used to manage the network slices, including allowing or not allowing access to the network slices.

When access to a managed entity is requested (e.g., by a UE 104), a feasibility check is performed to verify that the requested access can be provided. This feasibility check includes checking for resource used by the managed entity itself as well as resources for the automation system. Accordingly, the feasibility check verifies that the requested access can be provided and that the automation system can manage the network slices providing the requested access. This feasibility check is performed, for example, by the core network 106.

A feasibility check may employ open and closed control loops. Open loops involve the operator (e.g., a human) to be a part of at least one of the stages in the loop, while in the closed loop stage the operator only defines a goal for the closed control loop and the loop, once configured, runs automatically. Both control loops attempt in controlling the status of a managed object or entity trying to keep it as close as possible to the specified goal(s).

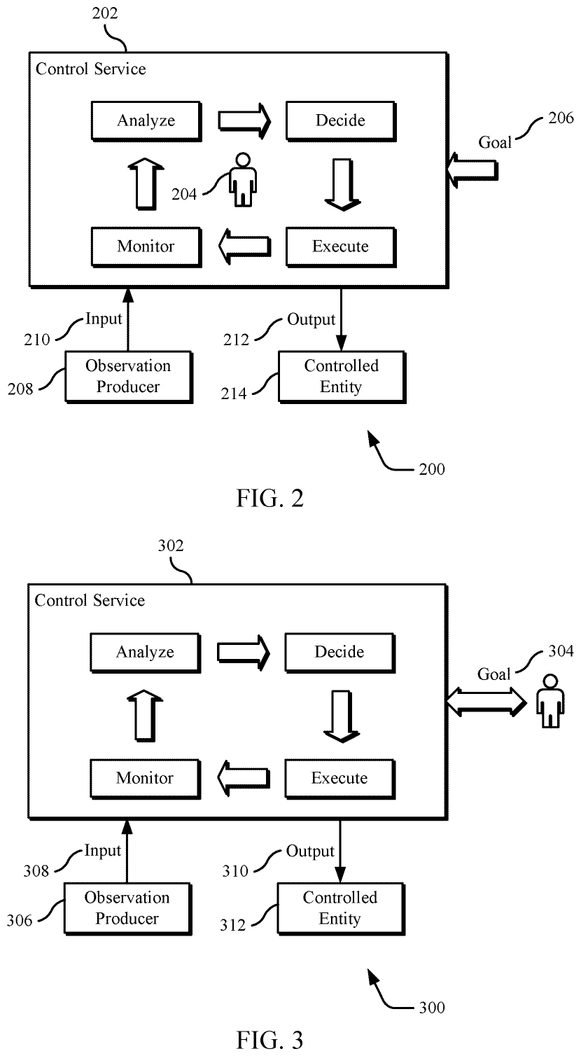

FIG. 2 illustrates an example of an open loop 200. As illustrated, a control service 202 includes a loop of actions including monitoring, analyzing, deciding, and executing. An operator 204 is involved in at least one of these actions. These actions are based on a goal 206 provided to the control service 302. An observation producer 208 provides an input 210 to the control service 202 and, based on the goal 206, the control service 202 outputs an output 212 to a controlled entity 214. The observation producer 208 is a provider of data that the control service 202 (e.g., the analyzing action) uses, such as another device, managed entity, sensor, and so forth. The controlled entity 214 is, for example, a managed entity.

FIG. 3 illustrates an example of a closed loop 300. As illustrated, a control service 302 includes a loop of actions including monitoring, analyzing, deciding, and executing. These actions are based on a goal 304 provided to the control service 302. However, the control service 302 differs from the control service 202 of FIG. 2 in that an operator is not involved in any of the loop of actions. However, the operator may be involved in provided a goal 304 to the control service 202. An observation producer 306 provides an input 308 to the control service 302 and, based on the goal 304, the control service 302 outputs an output 310 to a controlled entity 312. The observation producer 306 is a provider of data that the control service 302 (e.g., the analyzing action) uses, such as another device, managed entity, sensor, and so forth. The controlled entity 312 is, for example, a managed entity.

Network slicing allows the operator to support different services for different vertical customers (e.g., automotive (v2x), IoT, enhanced mobile broadband (eMBB), Industry 4.0 (e.g., ultra reliable low latency communications (URLLC))). The network slices are hosted over virtualized infrastructure across management domains. Closed loops may be used as an enabler for achieving automation in network slicing.

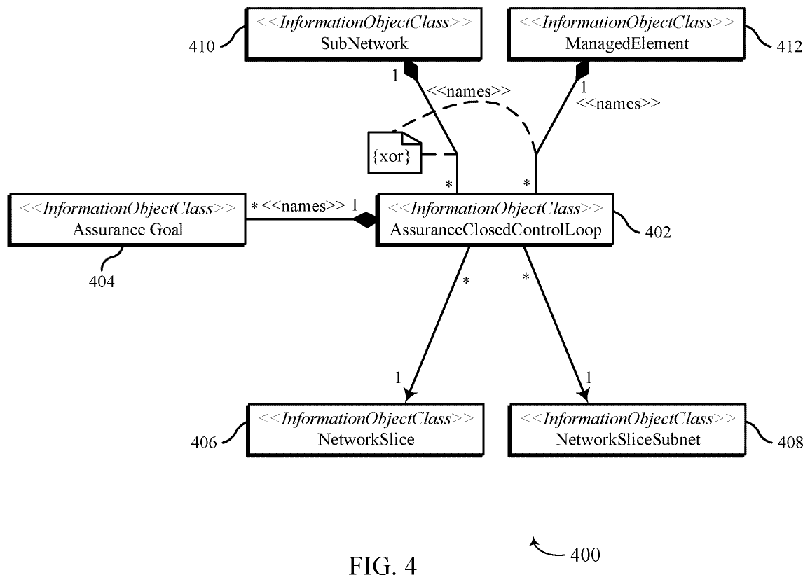

FIG. 4 illustrates an example of an information model 400 that supports managed entity feasibility check with automatic enabler feasibility check in accordance with aspects of the present disclosure. The information model 400 describes a closed control loop, which may also be referred to as an assurance closed control loop. Each assurance control loop 402 can consist of one or more assurance goals (or closed loop goals) 404 and many closed loops can act on a network slice 406 or 408 or a network slice subnet 410 or 412.

The assurance goal(s) corresponding to a closed loop can be set by any authorized closed loop consumer and consists of an assurance target list (e.g., assuranceTargetList) which is, for example, a list of name-value pairs that indicate a key performance indicator (KPI) goal that the closed loop is to try to achieve. This KPI goal is also referred to herein as an assurance goal or the control loop goal. These goals may be, for example, an optimization related criterion (e.g., maximum or minimum) an inequality (e.g., less than or greater than), an equality constraint (e.g., name=value as currently specified), and so forth. Different entities may set different goals at different levels. Different consumers (responsible for different network slice instances or different network slice subnet instances) may set different goals for the closed loops responsible for their network slice instances.

Management domains are a collection of resources that have their own management system. A management system is, for example, any set of management services or their implementations in management functions. Thus, management domains include things such as vendor devices with their own management system, vendor solutions, technical domains such as 3rd Generation Partnership Project (3GPP) core, 3GPP radio access network (RAN), cloud domains, datacenters, transport networks with their own controllers, operator administrative domains, country domains and so forth. Additional discussion of management domains can be found in ETSI Group Specification (GS) Zero touch network and Service Management (ZSM) 007.

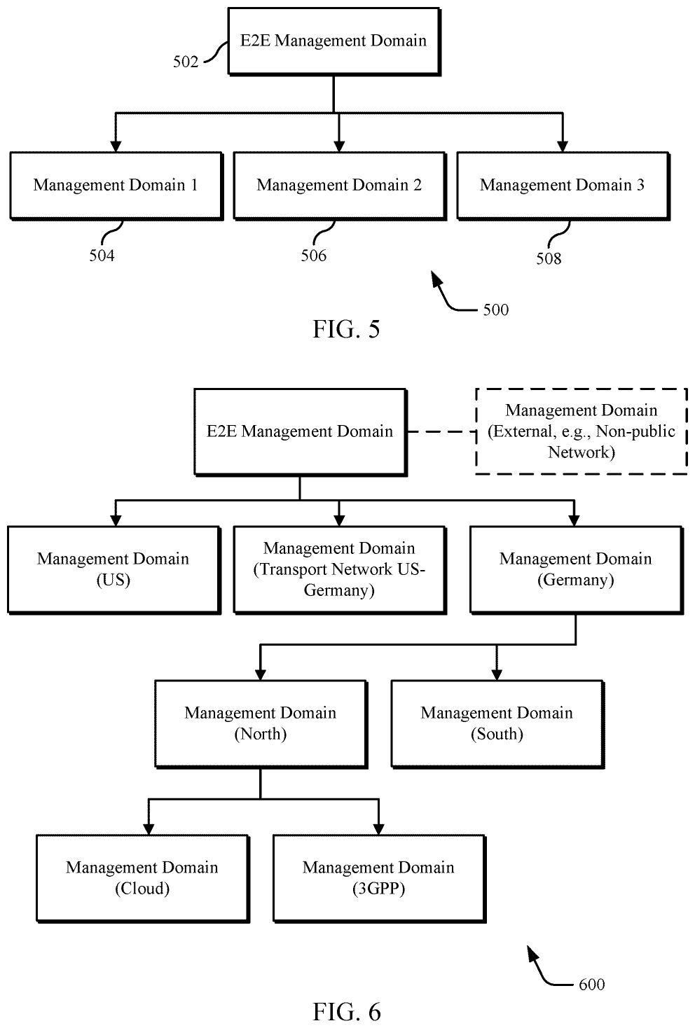

FIG. 5 illustrates an example 500 of a logical representation of management domains that supports managed entity feasibility check with automatic enabler feasibility check in accordance with aspects of the present disclosure. The example 500 shows management domains in a logical deployment representation in an operator network. As illustrated, the example 500 includes a top E2E management domain 502 and three management domains 504, 506, and 508 in a level or layer below the E2E management domain 502.

FIG. 6 illustrates an example 600 of a deployment scenario of management domains that supports managed entity feasibility check with automatic enabler feasibility check in accordance with aspects of the present disclosure. The example 600 shows how an example possible deployment of management domains for an operator that provides service in US and Germany. Only the German domain is further expanded to show the recursion in management domains. It is to be appreciated that FIG. 6 illustrates an example and further domains such as vendor specific management domains/equipment (not shown) may exist.

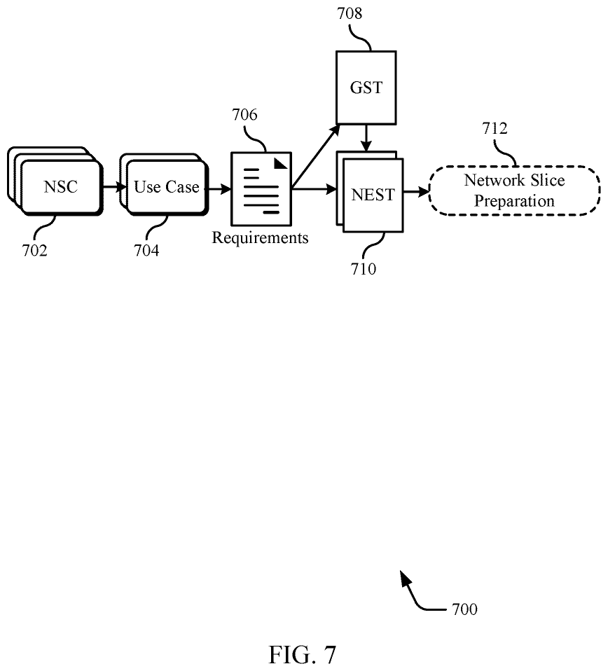

FIG. 7 illustrates an example 700 of generating a service description that supports managed entity feasibility check with automatic enabler feasibility check in accordance with aspects of the present disclosure. A network slice consumer (NSC) 702 identifies a desired use case 704 for a network slice. The use case 704 has associated requirements 706. The Groupe Speciale Mobile Association (GSMA) generic network slice template (GST) 708 helps identify the network requirements towards a slice instance. The GST 708 can be used to specify network requirements for a given slice instance. A filled-out GST based on the NSC requirements for a given slice is referred to as the network slice type (NEST) 710 identifying the type of network slice instance required. This NEST 710 is a service description of the type of network slice instance required and is used in network slice preparation 712 by the management system (e.g., both 3GPP and non-3GPP).

Returning to FIG. 1, the techniques discussed herein describe that the feasibility check for a managed entity also checks the feasibility of the automation enablers that provide the automation for the managed entity. This includes, for example, checking the availability of appropriate models for the required analytics, and the ability to configure the right closed loops with the appropriate goals. The automation enablers include, for example, monitoring equipment or sensors, components that analyze data (e.g., from the monitoring equipment or sensors), components that make decisions or take actions based on the analysis, assurance goals, and so forth.

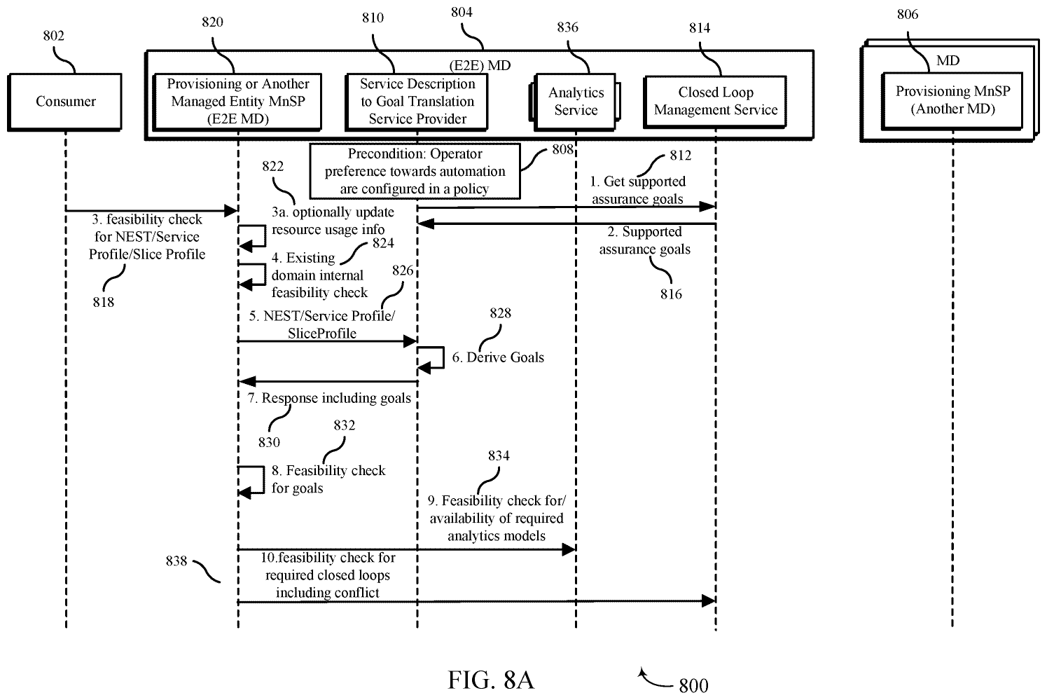

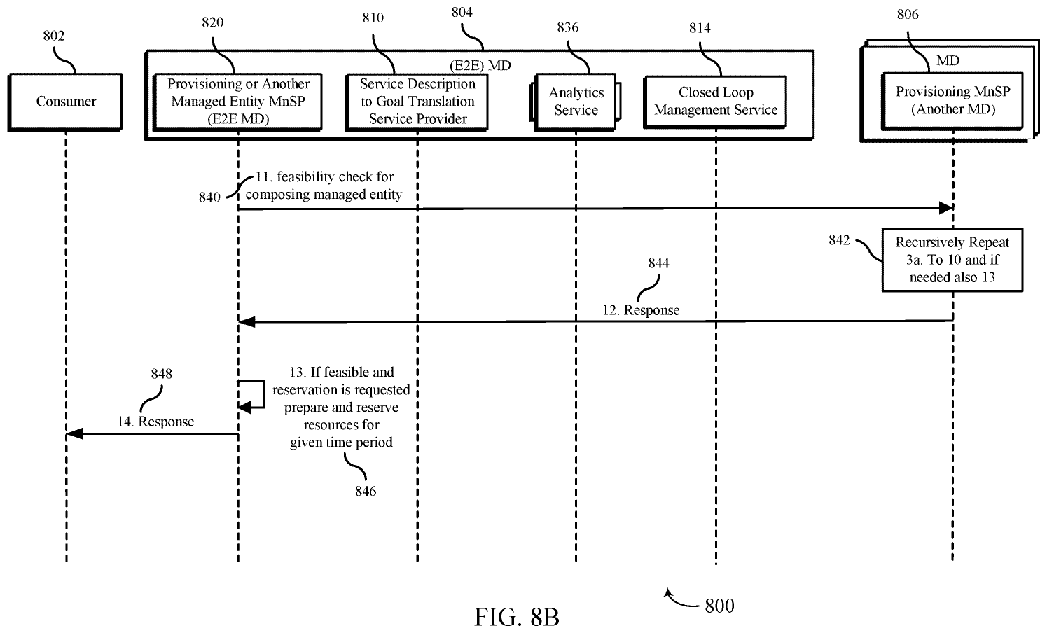

FIGS. 8A and 8B illustrate an example of a feasibility check 800 that supports managed entity feasibility check with automatic enabler feasibility check in accordance with aspects of the present disclosure. The feasibility check 800 is an E2E feasibility check. The feasibility check 800 illustrates a consumer 802, an E2E management domain (MD) 804, and one or more additional management domains 806. A precondition 808 of the feasibility check is that the operator has configured her policies that reflect operator requirements for automation in the service description to goal translation service provider 810.

Step 1. At 812, the service description to goal translation service provider 810 may optionally request the assurance goals that the closed loop management service 814 supports.

Step 2. At 816, the requested goals are provided to the service description to goal translation service provider 810.

Step 3. At 818, a request for feasibility checks with a service description such as the communication service, E2E service description, a network slice instance (NSI) (e.g., a NEST or Service profile), a network slice subnet instance (NSSI) (e.g., a SliceProfile), or a network function (NF) (e.g., NF descriptor), or a network service descriptor is received by the appropriate management service producer (for example, provision management service producer (MnSP) 820). Additionally reservation of resources may be requested for a given time period.

Step 3a. At 822, resource usage information may optionally be updated at this time.

Step 4. At 824, the MnSP 820 service performs a feasibility check if this service can be deployed in the current domain according to a feasibility check procedure, for example as defined in 3GPP technical specification (TS) 28.531.

Step 5. At 826, the service description is then forwarded to the service description to goal translation service provider 810.

Step 6. At 828, the service description to goal translation service provider 810 derives the goals based on operator configuration and the information in the service description. The goals are derived in various different manners. In one or more implementations, the goals are derived using a mapping table from service description (GST) parameters to the automation goals configured by the operator. Additionally or alternatively, the goals are derived using an analytics model trained based on the historical performance of various translations (for example a reinforcement learning model). Additionally or alternatively, the goals are derived using a hybrid where the initial version is configured by the operator and includes a neural network that learns over time the best performing translations.

Step 7. At 830, a list of automation goals to be configured in the network is provided to the MnSP 820.

Step 8. At 832, the MnSP 820 performs feasibility checks for those goals.

Step 9. At 834, feasibility checks on the availability of the analytics models required by the automation systems (such as closed loops), on the availability of the corresponding resource(s) in the analytics service producer 836, and on the availability of the corresponding data and resource requirements are performed.

Step 10. At 838, feasibility checks on the closed loop(s) itself is performed. This checks for at least one of irresolvable conflicting closed loops, resources required by the closed loops, appropriate authorizations for the closed loop, or the data required to feed the closed loops is available. Steps 9 and 10 are also referred to as performing a feasibility check on the automation enabler(s).

Step 11. At 840, a part of the communication service that can be hosted in the other management domain is sent to the other management domain 806 for feasibility check. This includes sending to the other management domain a part of the service description corresponding to the part of the communication service that can be hosted in the other management domain.

At 842, steps 3a to 10 and where needed 13 are repeated recursively internal to the additional management domain 806.

Step 12. At 844, the response to the feasibility of the partial service is sent back to the MnSP 820, indicating success or failure.

Step 13. At 846, if feasible and reservation is requested then resources may be prepared and reserved for the given time period. After the given time period the reservation (e.g., the reserved resources) are released. These resources are network resources used to fulfill the policies reflected in the service description and provide access to a managed entity, such as network bandwidth.

At step 14. At 848, the response to the consumer 802 is then provided indicating feasibility success or failure of the provisioning request and reservation details if requested.

In one or more implementations, this feasibility check 800 is also used every time prior to provisioning a managed entity, such as each time a request to access the managed entity.

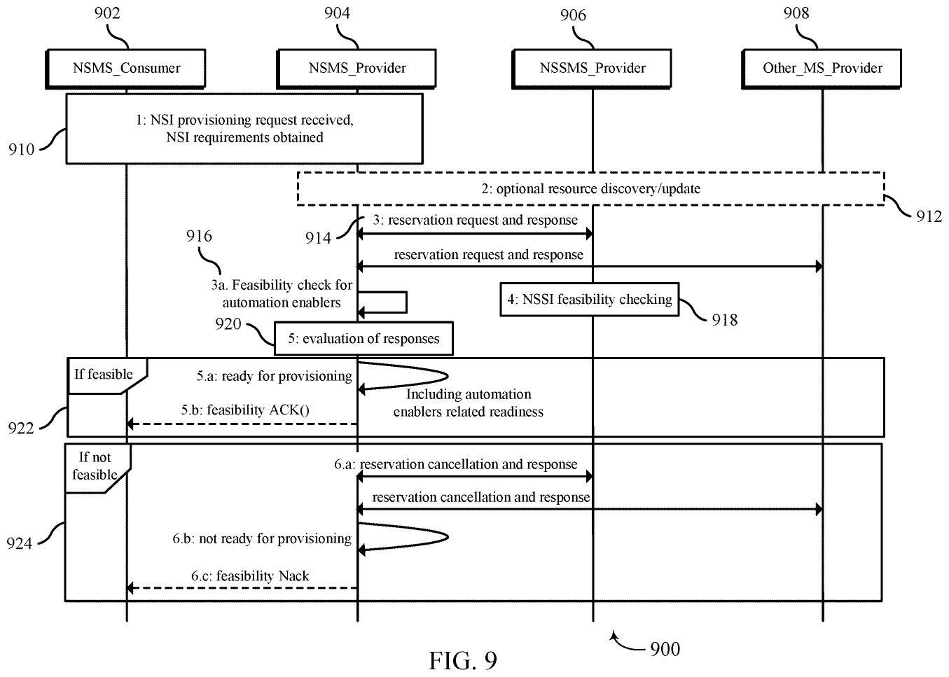

FIG. 9 illustrates an example of a feasibility check 900 that supports managed entity feasibility check with automatic enabler feasibility check in accordance with aspects of the present disclosure. The feasibility check 900 is a network slice instance feasibility check. The feasibility check 900 illustrates a network slice management service consumer (NSMS_Consumer) 902, a network slice management service provider (NSMS_Provider) 904, a network slice subnet management service provider (NSSMS_Provider) 906, and an optional other management service provider (Other_MS_Provider) 908.

Step 1. At 910, the NSMS_Provider 904 receives a provisioning network slice instance request from the NSMS_Consumer 902 with network slice related requirements (e.g., area information, user number, traffic demand, QoS Quality, whether the requested network slice instance could be shared).

Step 2. At 912, the NSMS_Provider 904 may optionally request information and updates from the NSSMS_Provider 906 and Other_MS_Provider 908 regarding the resources.

Step 3. At 914, the NSMS_Provider 904 sends reservation requests to the NSSMS_Provider 906 and (if needed) the Other_MS_Provider 908, e.g., management and orchestration (MANO), transport network (TN) manager. The NSMS_Provider 908 receives responses with information regarding allocated resources, e.g., their availability, identification information of reserved resources and so on.

Step 3a. At 916, the feasibility of goals, closed loop, analytics models, the resources they require, authorization, and the data they require to feed them is checked. Step 3a is also referred to as performing a feasibility check on the automation enabler(s).

Step 4. At 918, a reservation request to the NSSMS_Provider 906 can trigger network slice subnet instance feasibility checking.

Step 5. At 920, the NSMS_Provider 904 evaluates the responses to determine if the network slice requirements can be satisfied.

Step 5. At 922, if feasible, the NSMS_Provider 904 is ready for provisioning and if reservation is requested the automation enablers are prepared and reserved for the given time period (step 5.a), and an acknowledgement regarding reservation check results is optionally sent to the NSMS_Consumer 902.

Step 6. At 924, if not feasible, the NSMS_Provider 904 cancels reservations, optionally may receive acknowledgement (step 6.a), the NSMS_Provider 904 is not ready for provisioning (step 6.b), and the NSMS_Provider 904 may send negative acknowledgement regarding results of reservation check to the NSMS_Consumer 902.

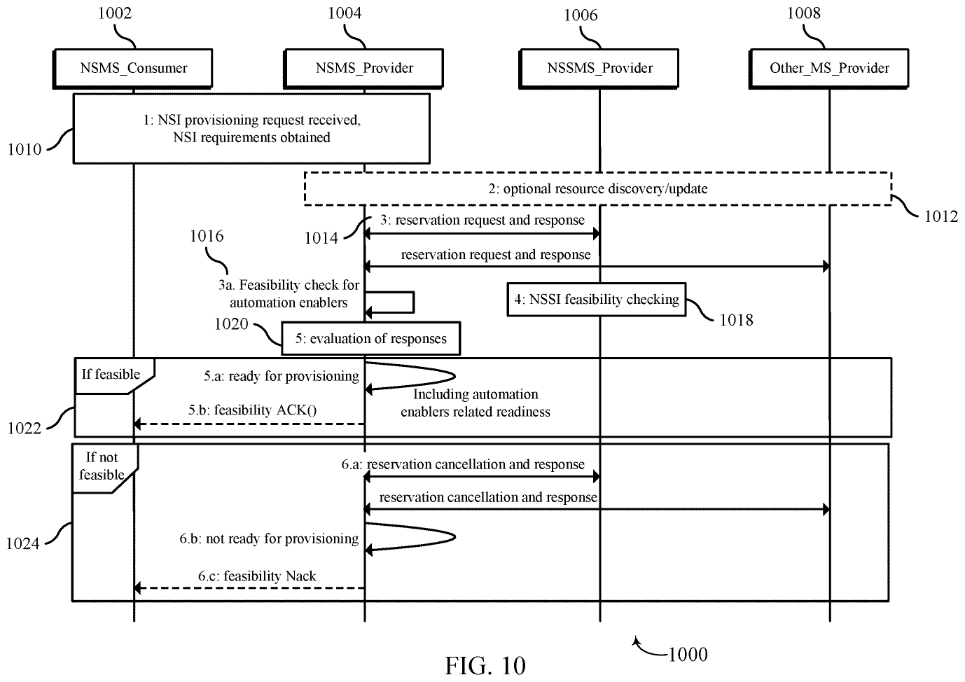

FIG. 10 illustrates an example of a feasibility check 1000 that supports managed entity feasibility check with automatic enabler feasibility check in accordance with aspects of the present disclosure. The feasibility check 1000 is a network slice subnet instance feasibility check. The feasibility check 1000 illustrates a network slice subnet management service consumer (NSMS_Consumer) 1002, a NSSMS_Provider 906, and an Other_MS_Provider 908.

Step 1. At 1004, the NSSMS_Provider 906 receives a provisioning network slice subnet instance request from the NSSMS_Consumer 1002 with network slice subnet related requirements (e.g., area information, user number, traffic demand, QoS Quality, whether the requested network slice instance could be shared). The request is evaluated and initial resources to be allocated are identified.

Step 2. At 1006, the NSSMS_Provider 906 may optionally request information and updates from the NSSMS_Provider 906 and Other_MS_Provider 908 regarding the resources.

Step 3. At 1008, the NSSMS_Provider 906 sends reservation requests to the Other_MS_Provider 908, e.g., MANO, TN manager. The NSSMS_Provider 906 receives responses with information regarding reserved resources, e.g., their availability, identification information of reserved resources and so on.

Step 3a. At 1010, the feasibility of goals, closed loop, analytics models, the resources they require, authorization, and the data they require to feed them is checked. 3a is also referred to as performing a feasibility check on the automation enabler(s).

Step 4. At 1012, the NSSMS_Provider 906 evaluates the responses to determine if the network slice subnet requirements can be satisfied.

If feasible, at 1014 the NSSMS_Provider 906 is ready for provisioning, including the automation enablers are prepared and if reservation is requested the automation enablers are reserved for the given time period (step 5.a), and acknowledgement regarding reservation check results can optionally be sent to the NSSMS_Consumer 1002.

If not feasible, at 1016 the NSSMS_Provider 906 cancels reservations and optionally may receive acknowledgement (step 6.a), the NSSMS_Provider 906 is not ready for provisioning (step 6.b), and the NSSMS_Provider 906 may send negative acknowledgement regarding results of reservation check to the NSSMS_Consumer 1002.

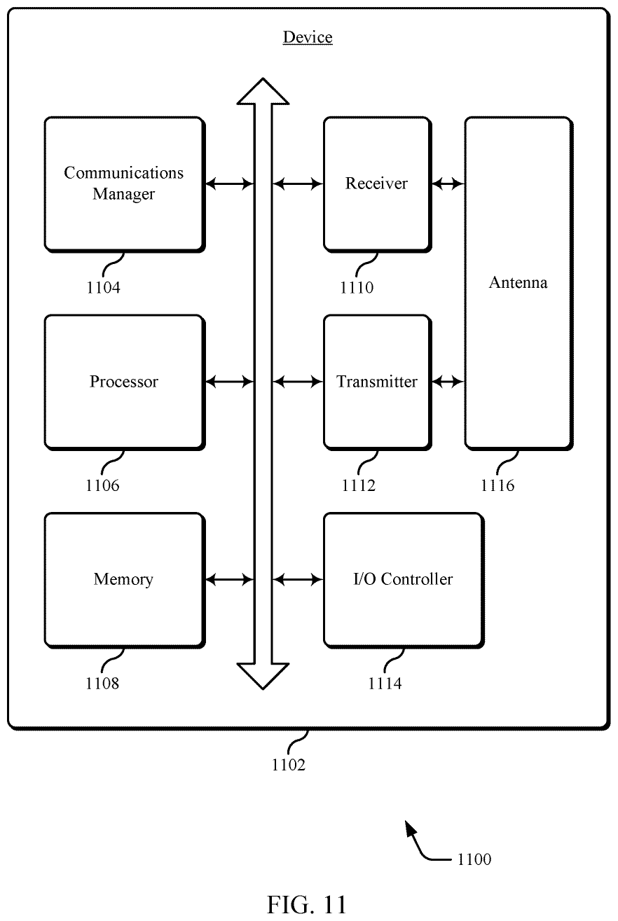

FIG. 11 illustrates an example of a block diagram 1100 of a device 1102 that supports managed entity feasibility check with automatic enabler feasibility check in accordance with aspects of the present disclosure. The device 1102 may be an example of a UE 104 as described herein. The device 1102 may support wireless communication and/or network signaling with one or more base stations 102, other UEs 104, network entities and devices, or any combination thereof. The device 1102 may include components for bi-directional communications including components for transmitting and receiving communications, such as a communications manager 1104, a processor 1106, a memory 1108, a receiver 1110, a transmitter 1112, and an I/O controller 1114. These components may be in electronic communication or otherwise coupled (e.g., operatively, communicatively, functionally, electronically, electrically) via one or more interfaces (e.g., buses).

The communications manager 1104, the receiver 1110, the transmitter 1112, or various combinations thereof or various components thereof may be examples of means for performing various aspects of the present disclosure as described herein. For example, the communications manager 1104, the receiver 1110, the transmitter 1112, or various combinations or components thereof may support a method for performing one or more of the functions described herein.

In some implementations, the communications manager 1104, the receiver 1110, the transmitter 1112, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1106 and the memory 1108 coupled with the processor 1106 may be configured to perform one or more of the functions described herein (e.g., by executing, by the processor 1106, instructions stored in the memory 1108).

Additionally or alternatively, in some implementations, the communications manager 1104, the receiver 1110, the transmitter 1112, or various combinations or components thereof may be implemented in code (e.g., as communications management software or firmware) executed by the processor 1106. If implemented in code executed by the processor 1106, the functions of the communications manager 1104, the receiver 1110, the transmitter 1112, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 1104 may be configured to perform various operations (e.g., receiving, monitoring, transmitting) using or otherwise in cooperation with the receiver 1110, the transmitter 1112, or both. For example, the communications manager 1104 may receive information from the receiver 1110, send information to the transmitter 1112, or be integrated in combination with the receiver 1110, the transmitter 1112, or both to receive information, transmit information, or perform various other operations as described herein. Although the communications manager 1104 is illustrated as a separate component, in some implementations, one or more functions described with reference to the communications manager 1104 may be supported by or performed by the processor 1106, the memory 1108, or any combination thereof. For example, the memory 1108 may store code, which may include instructions executable by the processor 1106 to cause the device 1102 to perform various aspects of the present disclosure as described herein, or the processor 1106 and the memory 1108 may be otherwise configured to perform or support such operations.

For example, the communications manager 1104 may support wireless communication and/or network signaling at a device (e.g., the device 1102, a UE) in accordance with examples as disclosed herein. The communications manager 1104 and/or other device components may be configured as or otherwise support an apparatus, such as a UE, including a transceiver; and a processor coupled to the transceiver. The communications manager 1104 and/or other device components may be configured as or otherwise support a means for wireless communication and/or network signaling at a UE.

The processor 1106 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1106 may be configured to operate a memory array using a memory controller. In some other implementations, a memory controller may be integrated into the processor 1106. The processor 1106 may be configured to execute computer-readable instructions stored in a memory (e.g., the memory 1108) to cause the device 1102 to perform various functions of the present disclosure.

The memory 1108 may include random access memory (RAM) and read-only memory (ROM). The memory 1108 may store computer-readable, computer-executable code including instructions that, when executed by the processor 1106 cause the device 1102 to perform various functions described herein. The code may be stored in a non-transitory computer-readable medium such as system memory or another type of memory. In some implementations, the code may not be directly executable by the processor 1106 but may cause a computer (e.g., when compiled and executed) to perform functions described herein. In some implementations, the memory 1108 may include, among other things, a basic I/O system (BIOS) which may control basic hardware or software operation such as the interaction with peripheral components or devices.

The I/O controller 1114 may manage input and output signals for the device 1102. The I/O controller 1114 may also manage peripherals not integrated into the device 1102. In some implementations, the I/O controller 1114 may represent a physical connection or port to an external peripheral. In some implementations, the I/O controller 1114 may utilize an operating system such as iOS®, ANDROID®, MS-DOS®, MS-WINDOWS®, OS/2®, UNIX®, LINUX®, or another known operating system. In some implementations, the I/O controller 1114 may be implemented as part of a processor, such as the processor 1106. In some implementations, a user may interact with the device 1102 via the I/O controller 1114 or via hardware components controlled by the I/O controller 1114.

In some implementations, the device 1102 may include a single antenna 1116. However, in some other implementations, the device 1102 may have more than one antenna 1116, which may be capable of concurrently transmitting or receiving multiple wireless transmissions. The receiver 1110 and the transmitter 1112 may communicate bi-directionally, via the one or more antennas 1116, wired, or wireless links as described herein. For example, the receiver 1110 and the transmitter 1112 may represent a wireless transceiver and may communicate bi-directionally with another wireless transceiver. The transceiver may also include a modem to modulate the packets, to provide the modulated packets to one or more antennas 1116 for transmission, and to demodulate packets received from the one or more antennas 1116.

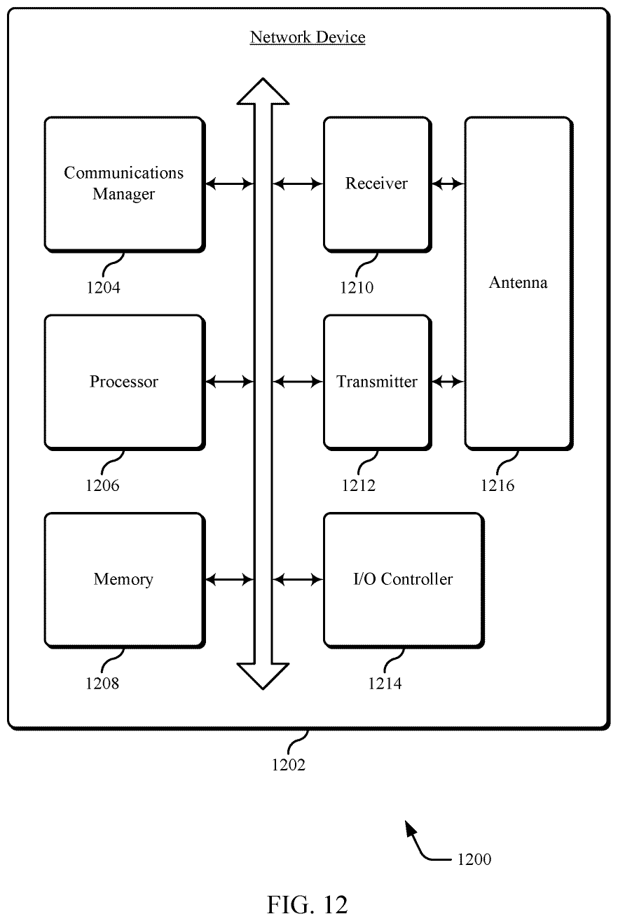

FIG. 12 illustrates an example of a block diagram 1200 of a device 1202 that supports managed entity feasibility check with automatic enabler feasibility check in accordance with aspects of the present disclosure. The device 1202 may be an example of a network device (e.g., a part of the core network 106), a base station 102 (e.g., a gNB), and so forth as described herein. The device 1202 may support wireless communication and/or network signaling with one or more base stations 102, other UEs 104, core network devices and functions (e.g., core network 106), or any combination thereof. The device 1202 may include components for bi-directional communications including components for transmitting and receiving communications, such as a communications manager 1204, a processor 1206, a memory 1208, a receiver 1210, a transmitter 1212, and an I/O controller 1214. These components may be in electronic communication or otherwise coupled (e.g., operatively, communicatively, functionally, electronically, electrically) via one or more interfaces (e.g., buses).

The communications manager 1204, the receiver 1210, the transmitter 1212, or various combinations thereof or various components thereof may be examples of means for performing various aspects of the present disclosure as described herein. For example, the communications manager 1204, the receiver 1210, the transmitter 1212, or various combinations or components thereof may support a method for performing one or more of the functions described herein.

In some implementations, the communications manager 1204, the receiver 1210, the transmitter 1212, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1206 and the memory 1208 coupled with the processor 1206 may be configured to perform one or more of the functions described herein (e.g., by executing, by the processor 1206, instructions stored in the memory 1208).

Additionally or alternatively, in some implementations, the communications manager 1204, the receiver 1210, the transmitter 1212, or various combinations or components thereof may be implemented in code (e.g., as communications management software or firmware) executed by the processor 1206. If implemented in code executed by the processor 1206, the functions of the communications manager 1204, the receiver 1210, the transmitter 1212, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 1204 may be configured to perform various operations (e.g., receiving, monitoring, transmitting) using or otherwise in cooperation with the receiver 1210, the transmitter 1212, or both. For example, the communications manager 1204 may receive information from the receiver 1210, send information to the transmitter 1212, or be integrated in combination with the receiver 1210, the transmitter 1212, or both to receive information, transmit information, or perform various other operations as described herein. Although the communications manager 1204 is illustrated as a separate component, in some implementations, one or more functions described with reference to the communications manager 1204 may be supported by or performed by the processor 1206, the memory 1208, or any combination thereof. For example, the memory 1208 may store code, which may include instructions executable by the processor 1206 to cause the device 1202 to perform various aspects of the present disclosure as described herein, or the processor 1206 and the memory 1208 may be otherwise configured to perform or support such operations.

For example, the communications manager 1204 may support wireless communication and/or network signaling at a device (e.g., the device 1202, a network device (e.g., a part of the core network 106), a base station 102 (e.g., a gNB)) in accordance with examples as disclosed herein. The communications manager 1204 and/or other device components may be configured as or otherwise support an apparatus, such as a network device or a, including a transceiver; a processor coupled to the transceiver, the processor and the transceiver configured to cause the apparatus to: receive a service description for a managed entity in a management domain; derive, from the service description, one or more automation enablers configurable in the management domain; perform a feasibility check for the entity as well as the one or more automation enablers; and output, based at least in part on the feasibility check, an indication of feasibility success or feasibility failure.

Additionally, the apparatus (e.g., a network device or base station) includes any one or combination of: where the processor and the transceiver are configured to cause the apparatus to: receive a request for reservation of resources associated with the managed entity for a given time period; reserve, in response to the feasibility check indicating success, the resources for the given time period; and release, after the given time period, the resources; where the processor and the transceiver are configured to cause the apparatus to: perform the feasibility check and output the indication of feasibility success or feasibility failure each time access to the managed entity is requested; where the service description is for a communication service, and the processor and the transceiver are configured to cause the apparatus to: transmit, to an additional management domain, a part of the service description corresponding to a part of the communication service that can be hosted by the additional management domain; and receive, from the additional management domain, an indication of feasibility success or feasibility failure resulting from the additional management domain performing a feasibility check for one or more automation enablers derived by the additional management domain from the part of the service description; where the service description is received from an additional management domain and the indication of feasibility success or feasibility failure is output by transmitting the indication of feasibility success or feasibility failure to the additional management domain; where the processor and the transceiver are configured to cause the apparatus to: perform, as part of the feasibility check, a feasibility check on at least one of resources required by one of the one or more automation enablers; perform, as part of the feasibility check, a feasibility check on appropriate authorizations for the one of the one or more automation enablers; and perform, as part of the feasibility check, a feasibility check on data used by the one of the one or more automation enablers; where the processor and the transceiver are configured to cause the apparatus to: perform, as part of the feasibility check, a feasibility check on an analytics model that is one of the one or more automation enablers; where the processor and the transceiver are configured to cause the apparatus to: perform, as part of the feasibility check, a feasibility check on a closed loop that is one of the one or more automation enablers; where the one or more automation enablers include at least one of an analytics model, a closed loop, or an assurance goal; where the managed entity comprises a network slice instance, a network slice subnet instance, a network function, or an end to end service.

The communications manager 1204 and/or other device components may be configured as or otherwise support a means for wireless communication and/or network signaling at a network device or base station, including receiving a service description for a managed entity in a management domain; deriving, from the service description, one or more automation enablers configurable in the management domain; performing a feasibility check for the entity as well as the one or more automation enablers; and outputting, based at least in part on the feasibility check, an indication of feasibility success or feasibility failure.

Additionally, wireless communication at the network device or base station includes any one or combination of: further including: receiving a request for reservation of resources associated with the managed entity for a given time period; reserving, in response to the feasibility check indicating success, the resources for the given time period; and releasing, after the given time period, the resources; further including: performing the feasibility check and outputting the indication of feasibility success or feasibility failure each time access to the managed entity is requested; where the service description is for a communication service, and the method further comprises: transmitting, to an additional management domain, a part of the service description corresponding to a part of the communication service that can be hosted by the additional management domain; and receiving, from the additional management domain, an indication of feasibility success or feasibility failure resulting from the additional management domain performing a feasibility check for one or more automation enablers derived by the additional management domain from the part of the service description; where the service description is received from an additional management domain and the indication of feasibility success or feasibility failure is output by transmitting the indication of feasibility success or feasibility failure to the additional management domain; further including: performing, as part of the feasibility check, a feasibility check on at least one of resources required by one of the one or more automation enablers, appropriate authorizations for the one of the one or more automation enablers, or data used by the one of the one or more automation enablers; further including: performing, as part of the feasibility check, a feasibility check on an analytics model that is one of the one or more automation enablers; further including: performing, as part of the feasibility check, a feasibility check on a closed loop that is one of the one or more automation enablers; where the one or more automation enablers include at least one of an analytics model, a closed loop, or an assurance goal; where the managed entity comprises a network slice instance, a network slice subnet instance, a network function, or an end to end service.

The processor 1206 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1206 may be configured to operate a memory array using a memory controller. In some other implementations, a memory controller may be integrated into the processor 1206. The processor 1206 may be configured to execute computer-readable instructions stored in a memory (e.g., the memory 1208) to cause the device 1202 to perform various functions of the present disclosure.

The memory 1208 may include random access memory (RAM) and read-only memory (ROM). The memory 1208 may store computer-readable, computer-executable code including instructions that, when executed by the processor 1206 cause the device 1202 to perform various functions described herein. The code may be stored in a non-transitory computer-readable medium such as system memory or another type of memory. In some implementations, the code may not be directly executable by the processor 1206 but may cause a computer (e.g., when compiled and executed) to perform functions described herein. In some implementations, the memory 1208 may include, among other things, a basic I/O system (BIOS) which may control basic hardware or software operation such as the interaction with peripheral components or devices.

The I/O controller 1214 may manage input and output signals for the device 1202. The I/O controller 1214 may also manage peripherals not integrated into the device 1202. In some implementations, the I/O controller 1214 may represent a physical connection or port to an external peripheral. In some implementations, the I/O controller 1214 may utilize an operating system such as iOS®, ANDROID®, MS-DOS®, MS-WINDOWS®, OS/2®, UNIX®, LINUX®, or another known operating system. In some implementations, the I/O controller 1214 may be implemented as part of a processor, such as the processor 1206. In some implementations, a user may interact with the device 1202 via the I/O controller 1214 or via hardware components controlled by the I/O controller 1214.

In some implementations, the device 1202 may include a single antenna 1216. However, in some other implementations, the device 1202 may have more than one antenna 1216, which may be capable of concurrently transmitting or receiving multiple wireless transmissions. The receiver 1210 and the transmitter 1212 may communicate bi-directionally, via the one or more antennas 1216, wired, or wireless links as described herein. For example, the receiver 1210 and the transmitter 1212 may represent a wireless transceiver and may communicate bi-directionally with another wireless transceiver. The transceiver may also include a modem to modulate the packets, to provide the modulated packets to one or more antennas 1216 for transmission, and to demodulate packets received from the one or more antennas 1216.

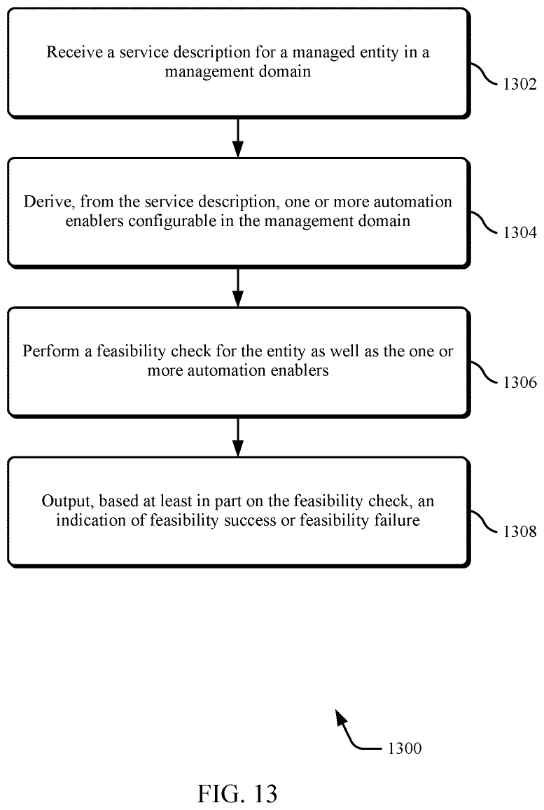

FIG. 13 illustrates a flowchart of a method 1300 that supports managed entity feasibility check with automatic enabler feasibility check in accordance with aspects of the present disclosure. The operations of the method 1300 may be implemented and performed by a device or its components, such as a network device as described with reference to FIGS. 1 through 12. In some implementations, the device may execute a set of instructions to control the function elements of the device to perform the described functions. Additionally, or alternatively, the device may perform aspects of the described functions using special-purpose hardware.

At 1302, the method may include receiving a service description for a managed entity in a management domain. The operations of 1302 may be performed in accordance with examples as described herein. In some implementations, aspects of the operations of 1302 may be performed by a device as described with reference to FIG. 1.

At 1304, the method may include deriving, from the service description, one or more automation enablers configurable in the management domain. The operations of 1304 may be performed in accordance with examples as described herein. In some implementations, aspects of the operations of 1304 may be performed by a device as described with reference to FIG. 1.

At 1306, the method may include performing a feasibility check for the entity as well as the one or more automation enablers. The operations of 1306 may be performed in accordance with examples as described herein. In some implementations, aspects of the operations of 1306 may be performed by a device as described with reference to FIG. 1.

At 1308, the method may include outputting, based at least in part on the feasibility check, an indication of feasibility success or feasibility failure. The operations of 1308 may be performed in accordance with examples as described herein. In some implementations, aspects of the operations of 1308 may be performed by a device as described with reference to FIG. 1.

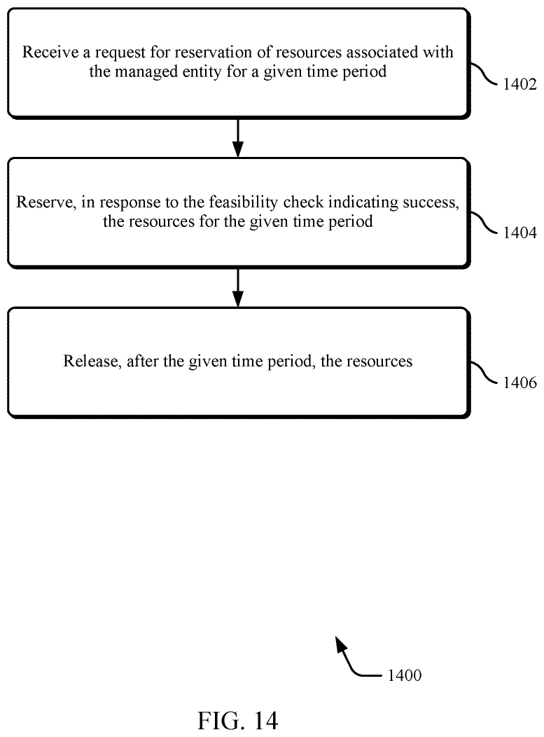

FIG. 14 illustrates a flowchart of a method 1400 that supports managed entity feasibility check with automatic enabler feasibility check in accordance with aspects of the present disclosure. The operations of the method 1400 may be implemented and performed by a device or its components, such as a network device as described with reference to FIGS. 1 through 12. In some implementations, the device may execute a set of instructions to control the function elements of the device to perform the described functions. Additionally, or alternatively, the device may perform aspects of the described functions using special-purpose hardware.

At 1402, the method may include receiving a request for reservation of resources associated with the managed entity for a given time period. The operations of 1402 may be performed in accordance with examples as described herein. In some implementations, aspects of the operations of 1402 may be performed by a device as described with reference to FIG. 1.

At 1404, the method may include reserving, in response to the feasibility check indicating success, the resources for the given time period. The operations of 1404 may be performed in accordance with examples as described herein. In some implementations, aspects of the operations of 1404 may be performed by a device as described with reference to FIG. 1.

At 1406, the method may include releasing, after the given time period, the resources. The operations of 1406 may be performed in accordance with examples as described herein. In some implementations, aspects of the operations of 1406 may be performed by a device as described with reference to FIG. 1.

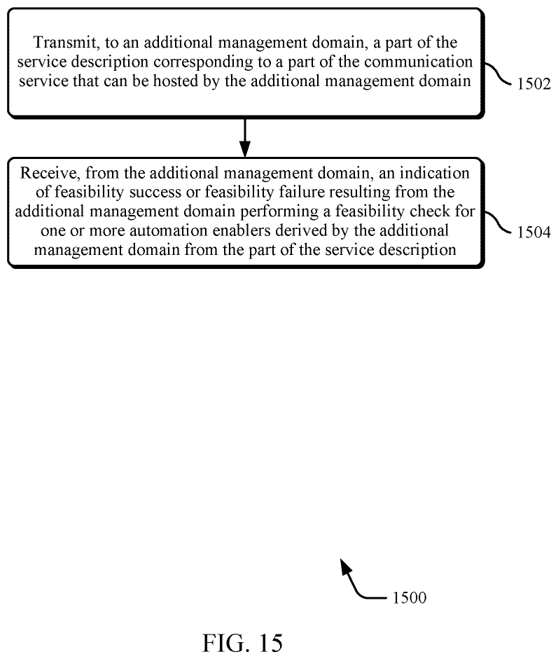

FIG. 15 illustrates a flowchart of a method 1500 that supports managed entity feasibility check with automatic enabler feasibility check in accordance with aspects of the present disclosure. The operations of the method 1500 may be implemented and performed by a device or its components, such as a network device as described with reference to FIGS. 1 through 12. In some implementations, the device may execute a set of instructions to control the function elements of the device to perform the described functions. Additionally, or alternatively, the device may perform aspects of the described functions using special-purpose hardware.

At 1502, the method may include transmitting, to an additional management domain, a part of the service description corresponding to a part of the communication service that can be hosted by the additional management domain. The operations of 1502 may be performed in accordance with examples as described herein. In some implementations, aspects of the operations of 1502 may be performed by a device as described with reference to FIG. 1.

At 1504, the method may include receiving, from the additional management domain, an indication of feasibility success or feasibility failure resulting from the additional management domain performing a feasibility check for one or more automation enablers derived by the additional management domain from the part of the service description. The operations of 1504 may be performed in accordance with examples as described herein. In some implementations, aspects of the operations of 1504 may be performed by a device as described with reference to FIG. 1.

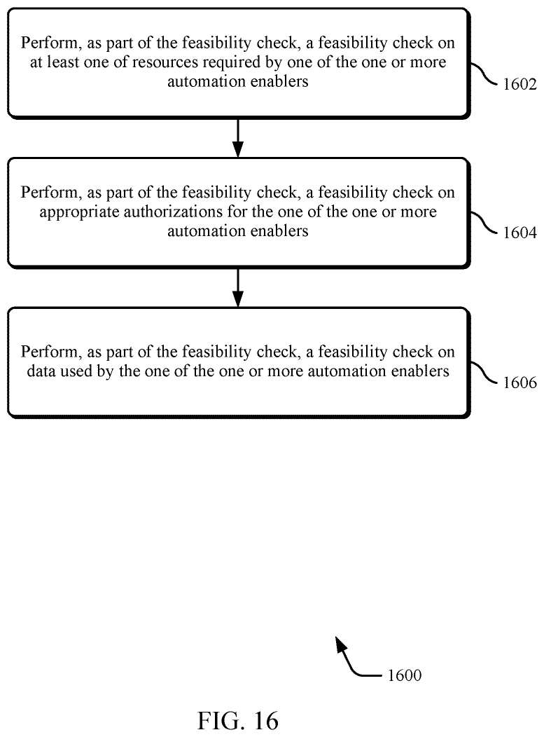

FIG. 16 illustrates a flowchart of a method 1600 that supports managed entity feasibility check with automatic enabler feasibility check in accordance with aspects of the present disclosure. The operations of the method 1600 may be implemented and performed by a device or its components, such as a network device as described with reference to FIGS. 1 through 12. In some implementations, the device may execute a set of instructions to control the function elements of the device to perform the described functions. Additionally, or alternatively, the device may perform aspects of the described functions using special-purpose hardware.

At 1602, the method may include performing, as part of the feasibility check, a feasibility check on at least one of resources required by one of the one or more automation enablers. The operations of 1602 may be performed in accordance with examples as described herein. In some implementations, aspects of the operations of 1602 may be performed by a device as described with reference to FIG. 1.

At 1604, the method may include performing, as part of the feasibility check, a feasibility check on appropriate authorizations for the one of the one or more automation enablers. The operations of 1604 may be performed in accordance with examples as described herein. In some implementations, aspects of the operations of 1604 may be performed by a device as described with reference to FIG. 1.

At 1606, the method may include performing, as part of the feasibility check, a feasibility check on data used by the one of the one or more automation enablers. The operations of 1606 may be performed in accordance with examples as described herein. In some implementations, aspects of the operations of 1606 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications, comprising:
at least one memory; and
at least one processor coupled with the at least one memory and configured to cause the apparatus to:
receive a service description for a managed entity in a management domain;
derive, from the service description, one or more automation enablers configurable in the management domain;
perform a feasibility check for the entity as well as the one or more automation enablers; and
output, based at least in part on the feasibility check, an indication of feasibility success or feasibility failure.

2. The apparatus of claim 1, wherein the at least one processor is configured to cause the apparatus to:
receive a request for reservation of resources associated with the managed entity for a given time period;
reserve, in response to the feasibility check indicating success, the resources for the given time period; and
release, after the given time period, the resources.

3. The apparatus of claim 1, wherein the at least one processor is configured to cause the apparatus to:
perform the feasibility check and output the indication of feasibility success or feasibility failure each time access to the managed entity is requested.

4. The apparatus of claim 1, wherein the service description is for a communication service, and the at least one processor is configured to cause the apparatus to:
transmit, to an additional management domain, a part of the service description corresponding to a part of the communication service that can be hosted by the additional management domain; and
receive, from the additional management domain, an indication of feasibility success or feasibility failure resulting from the additional management domain performing a feasibility check for one or more automation enablers derived by the additional management domain from the part of the service description.

5. The apparatus of claim 1, wherein the service description is received from an additional management domain and the indication of feasibility success or feasibility failure is output by transmitting the indication of feasibility success or feasibility failure to the additional management domain.

6. The apparatus of claim 1, wherein the at least one processor is configured to cause the apparatus to:
perform, as part of the feasibility check, a feasibility check on at least one of resources required by one of the one or more automation enablers;
perform, as part of the feasibility check, a feasibility check on appropriate authorizations for the one of the one or more automation enablers; and
perform, as part of the feasibility check, a feasibility check on data used by the one of the one or more automation enablers.

7. The apparatus of claim 1, wherein the at least one processor is configured to cause the apparatus to:
perform, as part of the feasibility check, a feasibility check on an analytics model that is one of the one or more automation enablers.

8. The apparatus of claim 1, wherein the at least one processor is configured to cause the apparatus to:
perform, as part of the feasibility check, a feasibility check on a closed loop that is one of the one or more automation enablers.

9. The apparatus of claim 1, wherein the one or more automation enablers include at least one of an analytics model, a closed loop, or an assurance goal.

10. The apparatus of claim 1, wherein the managed entity comprises a network slice instance, a network slice subnet instance, a network function, or an end to end service.

11. A method performed by an apparatus, the method comprising:
receiving a service description for a managed entity in a management domain;
deriving, from the service description, one or more automation enablers configurable in the management domain;
performing a feasibility check for the entity as well as the one or more automation enablers; and
outputting, based at least in part on the feasibility check, an indication of feasibility success or feasibility failure.

12. The method of claim 11, further comprising:
receiving a request for reservation of resources associated with the managed entity for a given time period;
reserving, in response to the feasibility check indicating success, the resources for the given time period; and
releasing, after the given time period, the resources.

13. The method of claim 11, further comprising:
performing the feasibility check and outputting the indication of feasibility success or feasibility failure each time access to the managed entity is requested.

14. The method of claim 11, wherein the service description is for a communication service, and the method further comprises:
transmitting, to an additional management domain, a part of the service description corresponding to a part of the communication service that can be hosted by the additional management domain; and
receiving, from the additional management domain, an indication of feasibility success or feasibility failure resulting from the additional management domain performing a feasibility check for one or more automation enablers derived by the additional management domain from the part of the service description.

15. The method of claim 11, wherein the service description is received from an additional management domain and the indication of feasibility success or feasibility failure is output by transmitting the indication of feasibility success or feasibility failure to the additional management domain.

16. The method of claim 11, further comprising:
performing, as part of the feasibility check, a feasibility check on at least one of resources required by one of the one or more automation enablers, appropriate authorizations for the one of the one or more automation enablers, or data used by the one of the one or more automation enablers.

17. The method of claim 11, further comprising:
performing, as part of the feasibility check, a feasibility check on an analytics model that is one of the one or more automation enablers.

18. The method of claim 11, further comprising:
performing, as part of the feasibility check, a feasibility check on a closed loop that is one of the one or more automation enablers.

19. The method of claim 11, wherein the one or more automation enablers include at least one of an analytics model, a closed loop, or an assurance goal.

20. An apparatus for wireless communications, comprising:
at least one memory; and
at least one processor coupled with the at least one memory and configured to cause the apparatus to:
transmit a service description for a managed entity in a management domain;
receive an indication of feasibility success or feasibility failure for the service description, the indication being based at least in part on a feasibility check for the managed entity as well as one or more automation enablers derived from the service description.
